(19) United States
(12) Patent Application Publication
(10) Pub. No.: US 2024/0207795 A1
(43) Pub. Date: Jun. 27, 2024

(54) SOLVENT COMPOSITION

(71) Applicant: Dow Global Technologies LLC, Midland, MI (US)

(72) Inventors: Jillian A. Emerson, Midland, MI (US); Scott T. Matteucci, Midland, MI (US); Brian R. Dorvel, Missouri City, TX (US); Vikram Prasad, Midland, MI (US); Manesh Nadupparambil Sekharan, Pearland, TX (US); Christopher J. Tucker, Midland, MI (US); Craig F. Gorin, Midland, MI (US); Amira A. Marine, Missouri City, TX (US)

(21) Appl. No.: 18/287,947

(22) PCT Filed: Mar. 22, 2022
(86) PCT No.: PCT/US2022/021251

§ 371 Date: Oct. 23, 2023

Related U.S. Application Data
(60) Provisional application No. 63/183,104, filed on May 3, 2021.

(51) Int. Cl. B01F 21/00; B32B 43/00

(52) U.S. Cl. CPC B01F 21/402; B32B 43/006

(57) ABSTRACT

An aqueous solvent composition (or separation fluid composition) including an aqueous mixture of (a) a solvent and (b) water for swelling, degrading, and/or fully dissolving adhesives; wherein the molecular weight of the solvent in the aqueous mixture is less than 1,000 g/mol; wherein the Hansen Solubility parameters of the solvent are in the following ranges: (i) a dispersive component from 15 MPa^{1/2} to 21 MPa^{1/2}; (ii) a polar component from 3 MPa^{1/2} to 10.5 MPa^{1/2}; and (iii) a hydrogen bonding component from 2 MPa^{1/2} to 18 MPa^{1/2}; wherein the solvent contains at least one aromatic group; wherein the solvent contains at least one hetero-atom; and wherein the adhesive at least swells to more than 50% by weight when soaked in the aqueous mixture; a process for treating an adhesive to swell, degrade, and/or fully dissolve the adhesive using the above aqueous mixture; a process for delaminating a multilayer packaging, a multilayer film or a multilayer article containing an adhesive using the above aqueous mixture; a process for recycling a multilayer packaging, a multilayer film or a multilayer article containing an adhesive using the above aqueous mixture; and a recycled packaging, film or article prepared by the above recycling process.

### FIELD

The present invention relates to a solvent composition; and more specifically, the present invention relates to an aqueous solvent composition for swelling, degrading or dissolving an adhesive.

### BACKGROUND

In an effort to reduce the amount of plastic waste generated in the environment, it is desired to re-use (recycle) components of multilayer packaging and multilayer films (herein “multilayer packaging/films”) which are commonly applied in single-use applications. However, the multiple layers of multilayer packaging/films typically cannot be directly recycled due to polymer incompatibility. One approach for dealing with the incompatibility issue has been to add compatibilizers to the polymers prior to recycling the multiple layers of multilayer packaging/films. However, it is still more advantageous to separate each of the layers for recovery of each material individually as a single stream thereby enabling re-use of each stream separately in desired applications without compromising or managing compatibilized material properties.

Another approach for employing an effective recycling method and achieving the reuse of the incompatible layers of a multilayer packaging/film is to delaminate the multiple layers of the multilayer packaging/films before subjecting the multiple layers of the multilayer packaging/films to a recycling process. An effective delamination procedure includes swelling, degrading, or dissolving the adhesive which is typically used to bind the multiple layers of the multilayer packaging/films together. Upon swelling, degrading, or dissolving the adhesive present in the multilayer packaging/films, any incompatible layers present in the multilayer packaging/films can be separated from the compatible layers and then the compatible layers can be recovered for reuse. Therefore, a proper separation fluid must be selected that functions to substantially swell, degrade, or dissolve the adhesive of the multilayer packaging/films when the multilayer packaging/films are treated with the proper separation fluid. The act of swelling, degrading, or dissolving the adhesive of the multilayer packaging/films using the proper separation fluid renders the multilayer packaging/films more easily susceptible to delamination under mechanical agitation. It is therefore desired to provide a proper separation fluid such as an aqueous solvent composition including an aqueous mixture of a solvent and water for swelling, degrading, or fully (i.e., substantially completely) dissolving adhesives.

Heretofore, various separation fluids and techniques have been used to treat multilayer materials (i.e., materials having two or more layers) for recycling the multilayer materials. For example, WO2019229235A1 discloses a separation fluid, method and apparatus for recycling multilayer materials using a passivation agent. The above reference describes a fluid for separating the layers of a multilayer packaging and the use of such separation fluid in a recycling process in which the multilayer packaging contains at least one metal layer and at least one additional layer. The separation fluid contains a passivating agent to protect the metal layer from chemical reactions. For example, the separation fluid contains water, carboxylic acid, carboxylate salt, and the passivation agent. The water miscible carboxylic acids present in the separation fluid causes delamination of the multilayer materials. However, the separation fluid of the above reference is not directed to swelling of the adhesive layers of the multilayer packaging to drive delamination of the multilayer packaging. Additionally, the carboxylic acid (acetic acid) disclosed in the above reference does not sufficiently swell all adhesives such as polyurethane-based adhesives. It would be desirous to provide a separation fluid and method that requires fewer safety measures than the separation fluid and method disclosed in the above reference.

WO2003104315A1 discloses a process for separating the layers of multilayered films used for packaging. The above reference describes an atmospheric pressure separation using heated organic solvent, acid, or water baths. Separation, as described in the above reference, is carried out by density/flotation in different stages of baths. The above reference further discusses solubility parameter requirements (Hildebrand) for solubilization of adhesives.

The above reference also discloses separating the layers of a multilayered film by removing the adhesive function of adhesives (e.g., polyurethane adhesives and polyvinyl alcohol adhesives) using solvents, acids, and water. The solvents include chloroform, toluene, tetrahydrofuran, xylene, acetone, and carbon tetrachloride; and the acids include protonic carboxylic acids such as acetic acid. The above reference also discloses solubility parameters near the adhesive solubility parameter with differences of lower than 1.7 Hildebrand. The separation disclosed in WO2003104315A1 is based on the cohesive energy density (CED) of the adhesive and applies what is already known in the art, i.e., that heating an adhesive at increasing temperatures lowers the CED of an adhesive which improves solubilization of the adhesive.

Therefore, the focus of WO2003104315A1 is directed to the use of 100% organic solvent baths; and discloses that solubility parameters fully drive dissolution of the adhesive. It would be desirous to provide a separation fluid and method that is not as complicated as the separation fluid and method disclosed in the above reference. It would also be desirous to provide an aqueous separation fluid to replace a non-aqueous separation fluid (e.g., an organic solvent) since non-aqueous separation fluids, such as those mentioned in the above reference, have additional safety concerns. In addition, it would be desirous to provide an aqueous separation fluid which includes a solvent having specific chemical moieties that can effectuate the swelling, degrading and/or the dissolution of adhesives.

U.S. Patent Application Publication No. 20170096540A1 discloses a method and fluid formulation for performing a swelling pretreatment of cured thermosetting resin materials prior to decomposition of the cured thermoset resin. The thermoset resin disclosed in the above reference includes epoxy, polyurethane, carbon fiber reinforced plastic, and the like. The fluid formulation for the swelling pretreatment contains an acid (e.g., acetic acid) mixed with a surfactant. In the above reference, water is not included in the separating fluid formulation, i.e., only a mixture of an acid and a surfactant are present in the separating fluid formulation. The above reference discloses that the mixture of acetic acid plus surfactant induces decomposition/swelling of the adhesive. However, acetic acid is insufficient to swell all types of adhesives, in particular, polyurethane-based adhesives. In addition, the surfactant disclosed in the above reference does not provide swelling of all types of adhesives, in particular, polyurethane-based adhesives. Therefore, it would be desirous to provide an aqueous separation fluid and method wherein the aqueous separation fluid (e.g., an aqueous solvent composition) includes a solvent that has specific chemical moieties which can effectuate the swelling, degradation, and/or the dissolution of adhesives, in particular, polyurethane-based adhesives.

### SUMMARY

One embodiment of the present invention is directed to a separation fluid composition including an aqueous mixture of (a) a solvent and (b) water for swelling, degrading, and/or fully (i.e., substantially completely) dissolving adhesives such as polyurethane-based adhesives.

In other embodiments, the solvent that is present in the separation fluid composition of the present invention has a molecular weight of less than 1,000 g/mol in one general embodiment; and predetermined Hansen Solubility parameters. The Hansen Solubility parameters of the solvent are described, for example, in C. M. Hansen's Hansen Solubility Parameters: A User's Handbook, Second Edition, CRC Press, 2007. For example, the aqueous solvent composition of the present invention has predetermined Hansen Solubility parameters in the following ranges: (i) a dispersive component in the range of from 15 MPa^{1/2} to 21 MPa^{1/2} in a general embodiment; (ii) a polar component in the range of from 3 MPa^{1/2} to 10.5 MPa^{1/2} in a general embodiment; and (iii) a hydrogen bonding component in the range of from 2 MPa^{1/2} to 18 MPa^{1/2} in a general embodiment.

In still other embodiments, the solvent contains at least one aromatic group; and at least one hetero-atom in the chemical structure of the solvent so that such chemical moieties can effectuate the swelling, degradation, and/or the dissolution of adhesives.

In yet other embodiments, the adhesive at least swells to more than 50% by weight when the adhesive is treated with the aqueous mixture (separation fluid composition) of the present invention. By “treating” it is meant that at least a portion of the adhesive is exposed to, or contacted with, the aqueous mixture.

In even still other embodiments, the solvent useful for preparing the separation fluid composition of the present invention has a molecular weight of less than 1,000 g/mol in one general embodiment; and includes: (i) at least one aromatic group; and (ii) at least one or more hetero-atoms.

Another embodiment of the present invention is directed to the use of the above aqueous solvent composition for swelling, degrading, and/or fully dissolving an adhesive, such as a polyurethane-based adhesive, which is present in the structure of a multilayer packaging, a multilayer film, or multilayer article (herein “multilayer packaging/film/article”).

In still another embodiment, the present invention is directed to a process for recycling a multilayer packaging/film/article containing an adhesive comprising the steps of: (I) providing a multilayer packaging/film/article containing an adhesive; (II) contacting the multilayer packaging/film/article with an aqueous solvent mixture for swelling, degrading, and/or fully dissolving the adhesive present in the multilayer packaging/film/article; (III) delaminating, or allowing delamination of, the multilayer packaging/film/article when the multilayer packaging/film/article is in contact with the aqueous solvent mixture to separate the multiple layers of the multilayer packaging/film/article; (IV) recovering the delaminated multiple layers of the multilayer packaging/film/article from step (III); (V) forming a recycled material from the recovered delaminated multiple layers of step (IV); and (VI) forming another different packaging, film or article from the recycled material.

It is an objective of the present invention to provide a novel and effective separation fluid composition for delaminating the layers of a multilayer packaging/film/article. It is another objective of the present invention to provide a novel and effective process for recycling the delaminated layers of multilayer packaging/film/article to assist in reducing the amount of plastic waste generated and introduced into the environment.

### DETAILED DESCRIPTION

Temperatures herein are in degrees Celsius (° C.).

“Room temperature (RT)” and “ambient temperature” herein means a temperature between 20° C. and 26° C., unless specified otherwise.

The term “swelling”, “degrading” or “dissolving”, with reference to an adhesive strip, herein means an uptake of solvent by the adhesive to provide a greater than 50 wt % mass change of the adhesive after soaking the adhesive strip in a separation fluid composition, thereby reducing the mechanical integrity of the adhesive strip such that the adhesive strip cannot be handled without falling apart; or such that a molecular integration of the adhesive strip into the separation fluid composition occurs.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

As used throughout this specification, the abbreviations given below have the following meanings, unless the context clearly indicates otherwise: “=” means “equal(s)” or “equal to”; “<” means “less than”; “>” means “greater than”; “≤;” means “less than or equal to”; ≥” means “greater than or equal to”; “@” means “at”; “MT”=metric ton(s); g=gram(s); mg=milligram(s); kg=kilogram(s); L=liter(s); mL=milliliter(s); g/L=gram(s) per liter; “g/cm³” or “g/cc”=gram(s) per cubic centimeter; “kg/m³=kilogram(s) per cubic meter; ppm=parts per million by weight; pbw=parts by weight; rpm=revolutions per minute; m=meter(s); mm=millimeter(s); cm=centimeter(s); m=micron(s), min=minute(s); s=second(s); ms=millisecond(s); hr=hour(s); Pa=pascals; MPa=megapascals; Pa-s=pascal second(s); mPa-s=millipascals second(s); g/mol=gram(s) per mole(s); g/eq=gram(s) per equivalent(s); Mn=number average molecular weight; MW=weight average molecular weight; pts=part(s) by weight; 1/s or sec⁻¹=reciprocal second(s) [s⁻¹]; ° C.=degree(s) Celsius; psig=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

One objective of the present invention is to produce a solvent composition for swelling, degrading, and/or fully dissolving adhesives used in preparing articles such as multilayer packaging/film/article. For example, in one embodiment of the present invention, the solvent composition includes an aqueous mixture of: (a) a solvent, (b) a diluent such as water, and (c) any other desired optional component(s). The aqueous solvent composition of the present invention is capable of swelling, degrading, and/or fully dissolving adhesives. The properties of the solvent present in the aqueous solvent composition include, for example: (1) a molecular weight of less than 1,000 g/mol in one embodiment, less than 500 g/mol in another embodiment, and less than 355 g/mol in still another embodiment; (2) Hansen Solubility parameters in the following ranges: (i) a dispersive component in the range of from 15 MPa^{1/2} to 21 MPa^{1/2}; (ii) a polar component in the range of from 3 MPa^{1/2} to 10.5 MPa^{1/2}; and (iii) a hydrogen bonding component in the range of from 2 MPa^{1/2} to 18 MPa^{1/2}; and (3) the following chemical constituents: (i) at least one aromatic group; and (ii) at least one or more hetero-atoms. The aqueous solvent composition beneficially provides at least an effective swelling of an adhesive. For example, the swelling is greater than or equal to 50% by weight in one general embodiment.

In a general embodiment, the solvent used in the present invention can be a solvent material containing at least one aromatic group; and at least one hetero-atom. The term “hetero-atom”, as used herein, includes any atom that is not a carbon or hydrogen atom. For example, preferred hetero-atoms useful in the present invention include silicon, fluorine, chlorine, oxygen, nitrogen, boron, bromine, and phosphorus. In a preferred embodiment, the hetero-atoms include nitrogen or oxygen. Non-limiting examples of functional groups which would include a hetero-atom and which could be part of the solvent molecules include amines, alcohols, esters, ethers, and aldehydes.

The at least one aromatic group of the solvent includes, for example aromatic(s) with at least a five-member ring. Exemplary of 5-member rings include: furan, pyrrole, thiophene, imidazole, pyrazole, oxazole, isoxazole, thiazole, fused rings thereof, and mixtures thereof. Exemplary of 6-member rings include: benzene, pyridine, pyrazine, pyrimidine, pyridazine, 1,2,3-triazine, 1,2,4-triazine, 1,3,5-triazine, fused rings thereof, and mixtures thereof. Exemplary of 7-member rings include: borepin, tropone, fused rings thereof, and mixtures thereof. Exemplary of 9-member rings include: azonine, fused rings thereof, and mixtures thereof.

Non-limiting examples of the solvent useful in the present invention can include solvents selected from the group consisting of one or more of the following: benzylamine; benzyl alcohol; diethyl phthalate; butyrophenone; guaiacol; dimethyl phthalate; butyl benzyl phthalate; aniline; benzaldehyde; m-cresol, o-cresol, p-cresol, propylene glycol monophenyl ether; ethylene glycol phenyl ether; diethylene glycol phenyl ether; dipropylene glycol phenyl ether; triethylene glycol phenyl ether; tripropylene glycol phenyl ether; 2-phenoxy ethanol; anisole; methyl benzoate; ethyl benzoate; propyl benzoate; n-butyl salicylate; methyl salicylate; n-benzyl pyrrolidone; 2-phenyl ethanol; 4-ethyl phenol; benzyl acetate; butyl benzoate; ethyl phenyl ether; 2,3-benzofuran; p-fluoroanisole; 4-(trifluoromethyl) acetophenone; 1,3-benzodioxole; 2-chloro-5-methylphenol; chlorophenol; acetylsalicylic acid; coniferyl alcohol; eugenol; methyl-p-toluate; 2,6-dimethyl phenol; 1,2-dimethoxy benzene; 2,4-dimethyl aniline; 3,4-dimethyl phenol; 1-chloro-4-ethoxy benzene; 2,6-dimethoxy phenol; benzoyl chloride; toluene diisocyanate; o-toluidine; 2-5 difluoronitrobenzene; 2-methoxyaniline; benzophenone; styrene oxide; n-methyl aniline; 4-chloroanisole; 4-chlorobenzyl alcohol; 4-fluoropropiophenone; phenyl acetate; iodobenzene; methoxy aniline; and mixtures thereof.

In a preferred embodiment, the solvent includes, for example, propylene glycol monophenyl ether; ethylene glycol phenyl ether; diethylene glycol phenyl ether; dipropylene glycol phenyl ether; and mixtures thereof.

In some embodiments, the solvent useful in the present invention can be selected from commercially available solvent products. For example, the solvent used to form the solvent composition can include DOWANOL™ EPh, DOWANOL™ PPh, DOWANOL™ DiEPh, DOWANOL™ DiPPh, DOWANOL™ TriPPh, DOWANOL™ TriEPh, (all available from Dow Inc.); and mixtures thereof.

The concentration of the solvent used in the aqueous solvent composition is from 0.1 wt % to 50 wt % in one general embodiment; and from 1 wt % to 49 wt % in another embodiment. Above 50 wt %, the mixture is no longer considered an aqueous solvent formulation.

The solvent used in the aqueous solvent formulation of the present invention has several advantageous properties and benefits. For example, the solvent has a molecular weight of less than 1,000 g/mol in one general embodiment, less than 500 g/mol in another embodiment, and less than 355 g/mol in still another embodiment. In other embodiments, the molecular weight of the solvent can be from 20 g/mol to 290 g/mol in another embodiment, and from 60 g/mol to 250 g/mol in still another embodiment.

The Hansen Solubility parameters of the solvent include for example: (i) a dispersive component; (ii) a polar component; and (iii) a hydrogen bonding component.

Exemplary of the ranges of component (i), a dispersive component, include from 15 MPa^{1/2} to 21 MPa^{1/2} in one embodiment; from 15.5 MPa^{1/2} to 20.5 MPa^{1/2} in another embodiment; and from 16 MPa^{1/2} to 20 MPa^{1/2} in still another embodiment.

Exemplary of the ranges of component (ii), a polar component, include from 3 MPa^{1/2} to 10.5 MPa^{1/2} in one embodiment; from 3.5 MPa^{1/2} to 10 MPa^{1/2} in another embodiment; and from 4 MPa^{1/2} to 9.7 MPa^{1/2} in still another embodiment.

Exemplary of the ranges of component (iii), a hydrogen bonding component, include from 2 MPa^{1/2} to 18 MPa^{1/2} in one embodiment; from 2.5 MPa^{1/2} to 17.5 MPa^{1/2} in another embodiment; and from 3 MPa^{1/2} to 17 MPa^{1/2} in still another embodiment.

In one preferred embodiment, the diluent useful in the present invention is water such as deionized water. The water can be sourced from any source desired.

The amount of the water used in the composition to form the aqueous solvent formulation of the present invention is from 1 wt % to 99.99 wt % in one general embodiment; from 50 wt % to 99.9 wt % in another embodiment; and from 51 wt % to 99 wt % in still another embodiment.

Although the aqueous solvent composition of the present invention, in one general embodiment, includes two components (a) and (b), the aqueous solvent composition may be formulated with a wide variety of optional additives to enable performance of specific functions while maintaining the excellent benefits/properties/performance of the present invention aqueous solvent composition. The optional component(s), component (c), may be added to component (a) of the solvent composition; or the optional component(s) may be added to component (b) of the solvent composition; or the optional component(s) may be added to both components (a) and (b) of the solvent composition prior to mixing components (a) and (b) together.

In some embodiments, exemplary of the optional additives, component (c), useful in the aqueous solvent formulation include enzymes; catalysts; surfactants; pH modifiers; polymers; wetting agents; chelants; rheology modifiers; corrosion inhibitors; and mixtures thereof.

The amount of the optional additives, component (c), useful for adding to the aqueous solvent formulation when used can be generally in the range of from 0 wt % to about 11 wt % in one embodiment; from 0.01 wt % to 15 wt % in another embodiment; and from 4.6 wt % to 10.5 wt % in still another embodiment based on the total weight of the components in the aqueous solvent formulation.

The aqueous solvent formulation used in the present invention has several advantageous properties and benefits when used to treat an adhesive. For example, the aqueous solvent composition of the present invention advantageously functions to swell, degrade and/or dissolve an adhesive. The swelling performance of the aqueous solvent composition is based on a percentage of effective swelling of the adhesive, as measured by gravimetric analysis. For example, an effective swelling of the adhesive by treating the adhesive with the aqueous solvent composition of the present invention is ≥50 wt % in one embodiment; ≥100 wt % in another embodiment; and >200 wt % in still another embodiment.

In some cases, the adhesive piece undergoes either full or partial dissolution, in which the adhesive strip is broken down into smaller chemical sub-units and solubilized in the solvent mixture; or the adhesive piece undergoes mechanical degradation, in which the adhesive strip cannot be handled without the adhesive falling apart.

The delamination performance of the aqueous solvent composition is based on separation of at least one film substrate layer of packaging/film containing two or more layers, as measured by spontaneous or mechanical removal of the at least one film substrate layer, wherein the removal is partially or substantially completed. In this embodiment, one or more layers in a multilayer film may be observed to delaminate completely or partially from the other layers in what was the multilayer film, which constitutes the delaminated layer lacking chemical or physical contact with the other components of the multilayer film over at least 10% of the delaminated layer's surface area, preferably 50% of delaminated layer's surface area, and most preferably 100% of delaminated layer's surface area; when the adhesive is exposed to treated with the aqueous solvent composition.

In a general embodiment, the adhesive that can be treated with the aqueous solvent composition of the present invention includes various adhesives. Non-limiting examples of the adhesive that can be treated with the aqueous solvent composition of the present invention can include adhesives selected from the group consisting of one or more of the following: polyurethane-based adhesives; polyester-based adhesives; acrylic-based adhesives; and mixtures thereof. Exemplary of some of the adhesives treatable by the separation fluid of the present invention include: polyurethanes, polyesters, acrylics, epoxies, natural rubber, polyolefins and olefin copolymers, ethylene vinyl acetate, silicone, starch, polyvinyl alcohol; and mixtures thereof. The adhesives useful in the present invention can be crosslinked or thermoplastic in nature.

In some embodiments, two or more different types of adhesives described above may be present in a single multilayer packaging/film/article. It is contemplated that the aqueous solvent composition of the present invention can be effectively used to treat such multilayer packaging/film/article containing the two or more different types of the adhesives described above.

While various different types of adhesives can be treated with the aqueous solvent composition of the present invention, in a preferred embodiment, polyurethane-based adhesives are treated with the aqueous solvent composition (i.e., the separation fluid formulation mixture) of the present invention because, heretofore: (1) polyurethane-based adhesives have been commonly used to adhere multiple layers of polymeric films together to form a multilayer packaging/film/article composite structure; and (2) polyurethane-based adhesives have been found to be very difficult to remove from multilayer packaging/film/article structures. The present invention aqueous solvent composition solves the removal problem of adhesives from multilayer packaging/film/article composite structures, in particular, wherein the layers of multilayer packaging/film/article composite structures are bond together with polyurethane-based adhesives.

Another embodiment of the present invention includes a process for treating an adhesive to swell, degrade, and/or fully dissolve the adhesive which includes the step of contacting the adhesive with the present invention aqueous solvent mixture composition described above for a sufficient amount of time to swell, degrade, and/or fully dissolve the adhesive.

The period of time for contacting the adhesive with the aqueous solvent mixture composition of the present invention, can be as fast as possible, i.e., the swelling, degrading, and/or full dissolution of the adhesive can occur instantaneously or in a few seconds. In general, effective swelling, degrading, and/or full dissolution of the adhesive can occur from 0.005 hr to 72 hr in one general embodiment; from 0.01 hr to 72 hr in another embodiment; from 0.05 hr to 72 hr in still another embodiment; from 0.1 hr to 72 hr in yet another embodiment; from 0.5 hr to 48 hr in even still another embodiment, and from 1 hr to 28 hr in even yet another embodiment, when the adhesive is treated with the aqueous solvent mixture composition (the separation fluid of the present invention).

The contacting step of the present invention process, for swelling, degrading, and/or fully dissolving the adhesive is carried out at a temperature of from 15° C. to 100° C. in one embodiment; from 18° C. to 85° C. in another embodiment, and from 20° C. to 70° C. in still another embodiment.

One of the advantages of the present invention process described above is that the contacting step of the process can be carried out by conventional processes and equipment known in the art. For example, the contacting step can be carried out under static mixing or high shear mixing conditions. In one preferred embodiment, the contacting step is performed with mixing. In other embodiments, a variety of separation methods after delamination can be used to recover the delaminated layers, including physical separation such as density separation, flocculation, or dissolution.

In still another embodiment of the present invention relates to a process for delaminating a multilayer packaging/film/article. In general, the process for delaminating a multilayer packaging/film/article containing an adhesive includes the steps of:
(A) providing a multilayer packaging/film/article containing an adhesive;
(B) contacting the multilayer packaging/film/article with an aqueous solvent mixture for swelling, degrading, and/or fully dissolving the adhesive in the multilayer packaging/film/article; and
(C) soaking the multilayer packaging/film/article in the aqueous solvent mixture for a predetermined period of time to delaminate, or allow to delaminate, the multiple layers of the multilayer packaging/film/article.

The multilayer packaging/film/article containing an adhesive can be any packaging, film, or article; and more particularly a multilayer packaging/film/article used in packaging applications for manufacturing various packaging materials and products. For example, typical multilayer packaging/film/article is used for food packaging, for cosmetic packaging, and for electronic packaging. Other applications include industrial applications, consumer goods packaging applications, and pharmaceutical applications.

In a broad embodiment, the multiple layers of the multilayer packaging/film/article can be made of various film substrates such as two or more substrates selected from the group consisting of polyolefins, polar polymers, metals, and mixtures thereof. For example, the film substrate can include one or more metals or polymeric layers selected from the group of high density polyethylene (HDPE); low density polyethylene (LDPE); linear low density polyethylene (LLDPE); medium density polyethylene (MDPE); polypropylene (PP) film; biaxially oriented PP (BOPP) film; oriented polyethylene (OPE); biaxially oriented polyethylene (BOPE); EVOH; nylon; polyethylene terephthalate (PET); polyvinyl chloride (PVC); polyvinyl alcohol (PvOH); polyolefin elastomers; polystyrene (PS) and its derivatives copolymers; aluminum; cellulose (which includes, for example, paper, paperboard, fiberboard, and cardboard); and combinations thereof.

In general, the contacting step (B) of the present invention process, for swelling, degrading, and/or fully dissolving the adhesive in a multilayer packaging/film/article is carried out using the following process conditions: a temperature from 15° C. to 100° C. in one embodiment; from 18° C. to 85° C. in another embodiment, and from 20° C. to 70° C. in still another embodiment.

In general, the period of time for the soaking step (C) of the present invention process, for effectively swelling, degrading, and/or fully dissolving the adhesive in a multilayer packaging/film/article is from 0.005 hr to 72 hr in one embodiment; from 0.5 hr to 48 hr in another embodiment, and from 1 hr to 28 hr in still another embodiment.

One of the advantages of the present invention process is that the steps of the process of the present invention described above can be carried out by several conventional processes and equipment known in the art.

In still other embodiments of the present invention relates to a process for recycling a multilayer packaging/film/article containing an adhesive. In general, the process for recycling a multilayer packaging/film/article containing an adhesive includes the steps of:
(I) providing a multilayer packaging/film/article containing an adhesive;
(II) contacting the multilayer packaging/film/article with an aqueous solvent mixture for swelling, degrading, and/or fully dissolving the adhesive in the multilayer packaging/film/article;
(III) soaking the multilayer packaging/film/article in the aqueous solvent mixture for a predetermined period of time to delaminate, or allow to delaminate, the multiple layers of the multilayer packaging/film/article;
(IV) recovering the delaminated multiple layers of the multilayer packaging/film/article from step (III);
(V) forming a recycled material from the recovered delaminated multiple layers of step (IV); and
(VI) forming another different packaging, film or article from the recycled material of step (V), wherein the packaging, film or article is a multilayer structure or a non-multilayer structure.

In general, the contacting step (II) of the present invention process, for swelling, degrading, and/or fully dissolving the adhesive in a multilayer packaging/film/article is carried out using the following process conditions: a temperature of from 15° C. to 100° C. in one embodiment; from 18° C. to 85° C. in another embodiment, and from 20° C. to 70° C. in still another embodiment.

In general, the period of time for the soaking step (III) of the present invention process, for effectively swelling, degrading, and/or fully dissolving the adhesive in a multilayer packaging/film/article is from 0.005 hr to 72 hr in one embodiment; from 0.5 hr to 48 hr in another embodiment, and from 1 hr to 28 hr in still another embodiment.

The step (IV) of the above process for recovering the delaminated multiple layers of the multilayer packaging/film/article can be carried out with physical separation including, for example, density separation, flocculation, or dissolution. The recovery step (IV) can be performed, for example, in a mixing tank, in a series of tanks, or in a continuous mixing process. The recovered delaminated multiple layers from step (IV) are used in step (V) to form a recycled material, i.e., the recovered delaminated multiple layers are re-used or recycled to form a recycled material that can be used to form a subsequent different packaging, film or article in step (V). Step (V) can be carried out by melting and extrusion. Using the melting and extrusion processes, pellets can be formed in step (V) prior to fabricating a new packaging, film or article from the pellets in step (VI). Alternatively, a new packaging, film or article can be formed directly from the recovered delaminated multiple layers of step (IV). The melting and extrusion processes may be performed using conventional equipment known to those skilled in the art such as single screw or twin-screw extruders.

The recycled material formed in step (V) includes for example, pellets, a monolayer or multilayer film, a monolayer or multilayer laminate, a packaging material, a molded product, and blends with other materials commonly practiced in the art of recycling.

The article in step (VI) formed from the recycled material of step (V) can include, for example, pellets, monolayer or multilayer films, monolayer or multilayer laminates, packaging materials, molded products, and extrudates, thermoformable materials and the like.

One of the advantages of the present invention process is that the steps of the process of the present invention described above can be carried out using several conventional processes and equipment known in the art.

If desired, the additional optional step(s) can be used in the above-described process to delaminate the multilayer packaging/film/article containing an adhesive. For example, in a preferred embodiment, the contacting step can be performed with mixing, such as static mixing or high shear mixing conditions. In addition, the separated material can undergo additional steps to aid in the recycling process including additional water washes, drying processes, additional sorting, and the like. The extrusion step can also include compounding with additional material or use of a melt-filtration process.

In one preferred embodiment, the aqueous solvent mixture is used to delaminate a multilayer packaging/film/article structure containing an adhesive by treating the multilayer packaging/film/article structure with the aqueous solvent mixture for a sufficient time to effectively swell, degrade, and/or dissolve the adhesive present in the multilayer packaging/film/article structure. In particular, the present invention solvent mixture is useful for delaminating multilayer packaging/film/article structures containing incompatible layers.

The above treatment process is very useful when recycling of the multilayer packaging/film/article structure is desired to reduce the amount of plastic waste for the benefit of the environment.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

The solvents and adhesives used in the Examples are described in Table I.

TABLE I
Raw Materials

| | | Chemical Name or | |
|---|---|---|---|
| Ingredient | Product | Structure of Product | Supplier |
| Solvent 1 | DOWANOL ™ EPh | C₆H₅OCH₂CH₂OH | The Dow Chemical |
| | | | Company (Dow) |
| Solvent 2 | DOWANOL ™ PPh | C₆H₅OCH₂CHOHCH₃ | Dow |
| Solvent 3 | DOWANOL ™ DiEPh | C₆H₅O(CH₂CH₂O)₂H | Dow |
| Solvent 4 | DOWANOL ™ DiPPh | C₆H₅O[CH₂CH(CH₃)O]₂H (major) | Dow |
| Solvent 5 | DOWANOL ™ TriEPh | Triethylene glycol phenyl ether | Dow |
| Solvent 6 | DOWANOL ™ TriPPh | Tripropylene glycol phenyl ether | Dow |
| Solvent 7 | DOWANOL ™ EPh6 | C₆H₅O(CH₂CH₂O)₆H | Dow |
| Solvent 8 | Benzyl alcohol | C₆H₅CH₂OH | Alfa Aesar |
| Solvent 9 | Diethyl phthalate | C₁₂H₁₄O₄ | TCI America |
| Solvent 10 | Triethylenetetramine | C₆H₁₈N₄ | Sigma |
| Solvent 11 | Benzylamine | C₆H₅CH₂NH₂ | Sigma Aldrich |
| Solvent 12 | Butyrophenone | C₁₀H₁₂O | Alfa Aesar |
| Solvent 13 | Guaiacol | C₆H₅OHOCH₃ | Acros Organics |
| Solvent 14 | 2-methoxyethyl acetate | C₅H₁₀O₃ | TCI America |
| Solvent 15 | Acetic acid | CH₃COOH | |
| Adhesive 1 | ADCOTE 102E/CATF | Polyol-urethane | Dow |
| Adhesive 2 | ROBOND L90M | Acrylic-urethane | Dow |
| Diluent | DI water | H₂O | Dow |

### General Procedure for Preparing Formulations and Adhesives

A sample of solvent mixture is prepared by mixing a solvent, as described in Table I, with a diluent to form a 10 wt % solvent in diluent (e.g., 0.4 g DOWANOL™ EPh [solvent] in 3.6 g DI water [diluent]).

An adhesive film having Adhesive 1 or Adhesive 2, as described in Table I, is cut into strips with the following dimensions: ˜ 1 cm×2 cm. Each of the cut pieces of adhesive film strips used in the Examples contain the following adhesive concentrations: for Adhesive 1: 0.01 g-0.08 g; and for Adhesive 2: 0.01 g-0.5 g.

### General Procedure for Testing

The adhesive strips are pre-weighed on an analytical balance. After the adhesive strips are pre-weighed, the adhesive strips are placed into 7.5 milliliters (mL) vials (Qorpack, GLC-000986) containing a clean, dry stir bar (V&P 773D-9). Then, 4 milliliters (mL) of the solvent mixture (e.g., 10 wt % DOWANOL™ EPh in water) is added to the vial and the vial is capped. The vials are placed on an Extended Core Module (XCM, Unchained labs) at the specified temperature, and the Module is set to stir for 5 hr to 6 hr at 300 revolutions per minute (rpm). The adhesive strips are soaked for a period of time of from 24 hr to 28 hr after the initial submersion of the strips in the solvent mixture. After soaking the sample adhesive in the solvent mixture, the sample adhesive film strips are removed from the vials with tweezers, patted down gently using a paper towel to remove excess moisture from the surface of the strips, and re-weighed on an analytical balance.

### Results

Tables II and Table III describe the properties of the film strips/adhesives as measured and recorded. To claim substantial adhesive swelling in accordance with the present invention, the sample adhesive strips are required to exhibit one of the following: (1) at least 50% increase in weight, (2) full dissolution, or (3) a loss in mechanical integrity which means that the sample adhesive piece is unable to be handled using tweezers without the adhesive piece falling apart. The term “dissolved” in Tables II and Table III means that a sample adhesive piece has lost its mechanical integrity or the sample adhesive piece has fully, or substantially completely, dissolved.

The results of the Examples described in Tables II and III teach the use of a specific solubility space range of the solvent along with requisite chemical moieties, which is novel. Additionally, the results of the Examples teach that an acid carboxylate (acetic acid) does not function as a swelling agent for the adhesive resins of the present invention.

TABLE II

| | | | | | Hansen Solubility | | | | |
|---|---|---|---|---|---|---|---|---|---|
| | | | | Mol. | Parameter | | | Adcote | Robond |
| | | | Conc. | weight | (J/cm³)^{1/2} | | | 102E/CATF | L90 M |
| Example No. | Additive | Chemical Nomenclature | (Wt %) | (g/mol) | δ_{d} | δₚ | δₕ | 20° C. | 20° C. |
| Comp. Ex. A | isopropanol^{a} | | 10 | 60.1 | 15.8 | 6.1 | 16.4 | 9% | 89% |
| Comp. Ex. B | n-propanol^{a} | | 10 | 60.1 | 16 | 6.8 | 17.4 | 5% | 90% |
| Inv. Ex. 1 | benzyl alcohol^{a} | | 10 | 108.14 | 18.4 | 6.3 | 13.7 | 358% | 139% |
| Comp. Ex. C | DOWANOL ™ PnB^{b} | Propylene glycol n-butyl ether | 10 | 132.2 | 15.2 | 4.2 | 10.5 | 24% | Dissolved |
| Comp. Ex. D | DOWANOL ™ DPnB^{b} | Dipropylene glycol n-butyl ether | 10 | 190.3 | 14.8 | 2.5 | 8.7 | 30% | Dissolved |
| Comp. Ex. E | DOWANOL ™ TPnB^{b} | Tripropylene glycol n-butyl ether | 10 | 284.4 | 14.8 | 1.7 | 7.9 | 21% | 220% |
| Comp. Ex. F | Hexyl CELLOSOLVE ™ ^{b} | Ethylene glycol hexyl ether | 10 | 146.2 | 16 | 6.9 | 10.9 | 23% | Dissolved |
| Comp. Ex. G | Hexyl CARBITOL ™ ^{b} | Diethylene glycol hexyl ether | 10 | 190.3 | 16 | 6 | 10 | 16% | Dissolved |
| Comp. Ex. H | Butyl CELLOSOLVE ™ ^{b} | Ethylene glycol n-butyl ether | 10 | 118.2 | 16 | 7.6 | 12.3 | 11% | Dissolved |
| Comp. Ex. I | Propyl CELLOSOLVE ™ ^{b} | Ethylene glycol propyl ether | 10 | 104.2 | 16.1 | 8 | 13.1 | 6% | 84% |
| Inv. Ex. 2 | DOWANOL ™ EPh^{b} | Ethylene glycol phenyl ether | 10 | 138.2 | 17.8 | 5.7 | 14.3 | 365% | 360% |
| Inv. Ex. 3 | DOWANOL ™ PPh^{b} | Propylene glycol phenyl ether | 10 | 152.2 | 17.4 | 5.3 | 11.5 | 340% | 220% |
| Comp. Ex. J | DOWANOL ™ EPh6^{b} | Poly(oxy-1,2-ethanediyl), alpha- | 10 | 358.4 | 17.4 | 6.6 | 10.6 | 12% | 123% |
| | | phenyl-omega-hydroxy | | | | | | | |
| Inv. Ex. 4 | Diethyl phthalate^{d} | | 10 | 222.24 | 17.6 | 9.6 | 4.5 | 238% | Dissolved* |
| Inv. Ex. 5 | DOWANOL ™ DiEPh^{b} | Diethylene glycol phenyl ether | 10 | 182.2 | 16.4 | 6.7 | 11.6 | 237% | Dissolved |
| Inv. Ex. 6 | DOWANOL ™ DiPPh^{b} | Dipropylene glycol phenyl ether | 10 | 210.2 | 17.6 | 5.9 | 10.7 | 297% | 114% |
| Comp. Ex. K | Triethylenetetramine^{c} | | 10 | 146.24 | 17.3 | 6.4 | 14.6 | 8% | Dissolved |
| Inv. Ex. 7 | Guaiacol^{d} | | 10 | 124.14 | 18 | 8.2 | 13.3 | 271% | Dissolved |

Notes for Table II
^{a}HSP value taken from: https://www.stevenabbott.co.uk/practical-solubility/hsp-basics.php
^{b}HSP value taken from: https://www.dow.com/content/dam/dcc/documents/en-us/catalog-selguide/327/327-00001-01-dow-oxygenated-solvents-selection-guide.pdf
^{c}HSP value taken from: HSPiP 5^{th} Edition
^{d}HSP value taken from: Brandrup, et al. (1999; 2005), Polymer Handbook (4^{th} Edition), Table 8. Solubility Parameters of Solvents in Increasing Order of δ, John Wiley & Sons.

TABLE III

| | | | | Hansen Solubility | | | | |
|---|---|---|---|---|---|---|---|---|
| | | | | Parameter | | | Adcote | Robond |
| | | Conc. | Mol. Wt. | (J/cm³)^{1/2} | | | 102E/CATF | L90 M |
| Example No. | Additive | (wt %) | (g/mol) | δ_{d} | δₚ | δₕ | 20° C. | 20° C. |
| Inv. Ex. 8 | Butyrophenone^{c} | 10 | 148.2 | 18 | 5.6 | 3.6 | 233% | 103%* |
| Inv. Ex. 9 | Benzylamine^{a} | 10 | 107.15 | 19 | 4.6 | 9.4 | Dissolved | Dissolved |
| Comp. Ex. L | 2-methoxyethyl | 10 | 118.13 | 15.9 | 5.5 | 11.6 | 6% | 51% |
| | acetate (or | | | | | | | |
| | ethylene glycol | | | | | | | |
| | methyl ether | | | | | | | |
| | acetate)^{a} | | | | | | | |
| Comp. Ex. M | Acetic acid^{a} | 5 | 60.05 | 14.5 | 8.0 | 13.5 | 5% | 35% |
| Comp. Ex. N | | 10 | | | | | 4% | 37% |

Notes for Table III
^{a}HSP value taken from: https://www.stevenabbott.co.uk/practical-solubility/hsp-basics.php
^{b}HSP value taken from: https://www.dow.com/content/dam/dcc/documents/en-us/catalog-selguide/327/327-00001-01-dow-oxygenated-solvents-selection-guide.pdf
^{c}HSP value taken from: HSPiP 5^{th} Edition
^{d}HSP value taken from: Brandrup, et al. (1999; 2005), Polymer Handbook (4^{th} Edition), Table 8. Solubility Parameters of Solvents in Increasing Order of δ, John Wiley & Sons.

1. A separation fluid composition for swelling, degrading, or fully dissolving adhesives
comprising an aqueous mixture of:
(a) a solvent; and
(b) water;
wherein the molecular weight of the solvent is less than 1,000 g/mol; wherein the Hansen Solubility parameters of the solvent comprise:
(i) a dispersive component from 15 Mpa^{1/2} to 21 Mpa^{1/2};
(ii) a polar component from 3 Mpa^{1/2} to 10.5 Mpa^{1/2}; and
(iii) a hydrogen bonding component from 2 Mpa^{1/2} to 18 Mpa^{1/2};
wherein the solvent contains at least one aromatic group; wherein the solvent contains at least one hetero-atom; and wherein when the aqueous mixture contacts an adhesive, the aqueous mixture swells the adhesive present in the aqueous mixture by more than 50 percent by weight.

2. The composition of claim 1, wherein the at least one aromatic group of the solvent is
a phenyl group.

3. The composition of claim 1, wherein the at least one hetero-atom of the solvent is a nitrogen or oxygen atom.

4. The composition of claim 1, further including a component (c) selected from the group consisting of enzymes; catalysts; surfactants; pH modifiers; polymers; wetting agents;
chelants; rheology modifiers; corrosion inhibitors; and mixtures thereof.

5. The composition of claim 1, wherein the adhesive is a polyurethane-based adhesive; a polyester-based adhesive; an acrylic-based adhesive, or mixtures thereof.

6. The composition of claim 1, wherein the solvent is selected from the group consisting of ethylene glycol phenyl ether, propylene glycol phenyl ether, diethylene glycol phenyl ether, dipropylene glycol phenyl ether, triethylene glycol phenyl ether, tripropylene glycol phenyl ether and mixtures thereof.

7. A process for treating adhesives to swell, degrade or fully dissolve the adhesives comprising contacting an adhesive with a solvent composition of claim 1.

8. A process for delaminating a multilayer packaging, a multilayer film or a multilayer
article containing an adhesive comprising the steps of:
(A) providing a multilayer packaging, multilayer film or multilayer article containing an adhesive;
(B) contacting the multilayer packaging, multilayer film or multilayer article with the solvent composition of claim 1 for swelling, degrading or fully dissolving the adhesive in the multilayer packaging, multilayer film or multilayer article; and
(C) soaking the multilayer packaging, multilayer film or multilayer article in the solvent composition of step (B) for a predetermined period of time to delaminate, or allow to delaminate, the multiple layers of the multilayer packaging, multilayer film or multilayer article.

9. The process of claim 8, wherein the soaking step (C) is carried out at a temperature of from 15° C. to 100° C. and for a period of time from essentially instantaneous to 72 hours.

10. A process for recycling a multilayer packaging, multilayer film or multilayer article containing an adhesive comprising the steps of:
(I) providing a multilayer packaging, multilayer film or multilayer article containing an adhesive;
(II) contacting the multilayer packaging, multilayer film or multilayer article with the composition of claim 1 for swelling, degrading or fully dissolving the adhesive in the multilayer packaging, multilayer film or multilayer article;
(III) soaking the multilayer packaging, multilayer film or multilayer article for a predetermined period of time to delaminate, or allow to delaminate, the multiple layers of the multilayer packaging, multilayer film or multilayer article;
(IV) recovering the delaminated multiple layers of the multilayer packaging, multilayer film or multilayer article from step (III);
(V) forming a recycled material from the recovered delaminated multiple layers of step (IV); and
(IV) forming another different packaging, film or article; wherein at least one of the layers of the different packaging, film or article contains recycled material of step (V).

11. The process of claim 10, wherein contacting step (II) is carried out at a temperature of from 18° C. to 85° C.

12. The process of claim 10, wherein the soaking step (III) is carried out at a temperature of from 20° C. to 100° C. and for a period of time of from 0.005 hour to 28 hours.

13. The process of claim 10, wherein the adhesive is selected from the group consisting of a polyurethane-based adhesive; a hydroxyl terminated polyester cured with an aliphatic isocyanate; an acrylic emulsion cured with an aliphatic isocyanate; and mixtures thereof.

14. A packaging, film or article structure made by the process of claim 10.
